(19) United States
(12) Patent Application Publication
(10) Pub. No.: US 2026/0084553 A1
(43) Pub. Date: Mar. 26, 2026

(54) CHARGER HANDLE FOR ELECTRIC VEHICLE CHARGING

(71) Applicant: VOLTPOST, INC., New York, NY (US)

(72) Inventors: Joern VICARI, San Francisco, CA (US); Jason Yuuki Miyata WOODRUFF, Oakland, CA (US); Alejandro Enrique VALLEJO, Oakley, CA (US)

(21) Appl. No.: 19/110,986

(22) PCT Filed: Sep. 12, 2023
(86) PCT No.: PCT/US2023/032560

§ 371 Date: Mar. 12, 2025

Related U.S. Application Data
(60) Provisional application No. 63/375,342, filed on Sep. 12, 2022.

(51) Int. Cl. B60L 53/16; B60L 53/18

(52) U.S. Cl. CPC B60L 53/16; B60L 53/18

(57) ABSTRACT

An EV charger handle includes a housing includes an overmold, a thorax, a barrel, and a charging cable insert that is perpendicular to the axis of an EV charging port. The overmold includes a light transmitting assembly and a light source. The EV charger handle includes a charging plug. The charging plug includes a switching grommet, a charging plug mount, a plurality of female 2024/059084 contact pins and a pin restrainer. The charging plug further includes an inner charging plug shell, an outer charging plug shell and a charging plug grommet. The inner charging plug shell is configured to house the switching grommet, the charging plug mount, the female contact pins, and the pin restrainer. The outer charging plug shell is configured to be secured with the inner charging plug shell by the charging plug grommet. The EV charger handle further includes a rotating latch.

### CROSS REFERENCE TO RELATED APPLICATIONS

This application claims priority to U.S. Provisional Application No. 63/375,342, filed on Sep. 12, 2022, the disclosure of which is incorporated herein by reference.

### FIELD OF DISCLOSURE

This disclosure relates to electric vehicle (EV) charging systems.

### BACKGROUND OF THE DISCLOSURE

Battery Electric Vehicles (BEV) or, just Electric Vehicles (EV) are charged through a variety of Direct Current (DC) and Alternating Current (AC) electric power sources. A typical charging station, also known as a charge point or EV supply equipment (EVSE), is a device that supplies electrical power for charging the batteries of plug-in EVs. Charging stations provide connectors that conform to a variety of international standards, housed in a charging handle. AC charging stations have charging handles that are commonly equipped with multiple connectors to be able to charge a wide variety of vehicles that utilize competing standards.

One problem with such charging stations is the absence of compact charging handles to facilitate charging in tight spaces. Typically, the charging handle of a charging station is a straight charging handle. That is, the charging handle extends directly out of a charging cable such that, when plugged into the battery, the charging handle has the same axis as that of the charging cable. This often forces the user to bend cables to fit tight charging spaces, leading to a partial or complete rupture of the insulation surrounding the high voltage wires over repetitive usage. This presents a potentially hazardous situation to the user. Further, at curbside charging stations, when the EV charging port is located on the road side of the car, the straight charging handle projects into the path of active traffic, bicycles or pedestrians and poses hazards in densely populated areas. During low-visibility conditions, the charging handle projecting into the path of active traffic, bicycles or pedestrians may not be readily visible and may pose a risk of collision.

Another problem with such charging stations is the absence of an indication of a charging status on the charging handle. Some, but not all EVs, include some means of visual indication while charging, on the EV side, to communicate to the user regarding the status of charging. However, if this indication is absent on the EV side, it is difficult for the user to assess the status of charging.

As EVs become more popular, curbside charging or charging in other limited space environments, such as garages and public parking lots, becomes increasingly necessary for the development of a convenient carbon neutral transportation infrastructure. The use of charging equipment in these limited space environments creates multiple problems. One of the problems is the need for a user to operate an EV charging station in the roadway during low visibility conditions. The current design of most standard EV charging handles is taken from the decades-old design of gas fuel pump nozzles, which were not designed with the public roadway in mind. They tend to extend significantly out from the side of vehicles, often in excess of one foot distance. Further, they are typically dark colored and are made with dull plastic material. These features present a collision hazard with oncoming traffic in roadways, resulting in serious damage.

Thus, a solution is needed to improve charging connections in tight-spaced environments, and for better visual indication on the charger side. Further, there is a need for a safer and a user-friendly EV charger handle that eliminates ambiguity for the user.

### SUMMARY OF THE DISCLOSURE

The present disclosure provides an electric vehicle (EV) charger handle that may include a housing, a charging cable insert perpendicular to the axis of the EV charger handle and configured to receive a charging cable from an EV charging station, and a charging plug configured to be inserted into an electrical receptacle in an EV. The charging plug may include a switching grommet. The switching grommet may include a push button embedded in the switching grommet. The charging plug may include a charging plug mount that may be configured to secure the EV charger handle into the EV. The charging plug may include a plurality of female contact pins that may be configured to secure an electric connection with male contact pins in the electrical receptacle in the EV. The charging plug may include a pin restrainer that may be configured to secure the plurality of female contact pins to the EV charger handle. The charging plug may include an inner charging plug shell that may be configured to house the switching grommet, the charging plug mount, the plurality of female contact pins, and the pin restrainer. The charging plug may include an outer charging plug shell. The outer charging plug shell may be secured to the inner charging plug shell by a charging plug grommet.

In an embodiment of the present disclosure, the EV handle may be configured to direct the charging cable from an EV charging station to the electrical receptacle in an EV at a 90 degree angle.

In an embodiment of the present disclosure, the housing may include an overmold, a thorax, and a barrel. The barrel may be configured to secure or mechanically bond the overmold with the EV charger handle.

In an embodiment of the present disclosure, the EV charger handle may further include a rotating latch positioned on the housing.

In an embodiment of the present disclosure, the rotating latch may be positioned on the thorax.

In an embodiment of the present disclosure, the EV charger handle may further include a light transmitting assembly configured to receive and transmit light from a light source.

In an embodiment of the present disclosure, the light source may be disposed inside the light transmitting assembly.

In an embodiment of the present disclosure, the EV charger handle may further include a processor in electronic communication with the light source.

In an embodiment of the present disclosure, the light source may be configured to be controlled by a wireless device.

In an embodiment of the present disclosure, the light source may be an LED.

In an embodiment of the present disclosure, the light source may further include a programmable RGB/RGB+W LED light source.

In an embodiment of the present disclosure, the overmold may include a light transmitting assembly configured to receive and transmit light from a light source.

In an embodiment of the present disclosure, the push button in the switching grommet may be configured to provide a waterproof seal to the EV charger handle, in response to being engaged by the rotating latch.

In an embodiment of the present disclosure, the rotating latch may facilitate control of dispense and retraction of a charging cable from an EV charging station.

In an embodiment of the present disclosure, the pin restrainer may be annular shaped.

In an embodiment of the present disclosure, the charging cable insert may include a cable strain relief. The cable strain relief can provide protection and relief from the stresses of wire and cable connections of the charging cable and can prevent the connections or cables of the charging cable from breaking.

In an embodiment of the present disclosure, a Hall Effect sensor board may be disposed on the charging plug mount.

### BRIEF DESCRIPTION OF THE FIGURES

For a fuller understanding of the nature and objects of the disclosure, reference should be made to the following detailed description taken in conjunction with the accompanying figures.

FIG. 1 is an illustration of a cross-section of an embodiment of the EV charger handle of the present disclosure.

FIG. 2 is an exploded view of an embodiment of the EV charger handle of the present disclosure illustrating the parts in the EV charger handle.

FIG. 3 is an illustration of an embodiment of the EV charger handle of the present disclosure providing a visual indication to a user.

FIG. 4A illustrates the hazard posed by an existing EV charger handle.

FIG. 4B illustrates an embodiment of the EV charger handle of the present disclosure providing a 90 degree cable angle.

FIG. 5 illustrates controlling the retraction and dispense of a charging cable using a rotating latch in the EV charger handle of the present disclosure.

FIG. 6 illustrates an embodiment of the EV charger handle operation.

FIG. 7 illustrates a perspective view of an embodiment of the EV charger handle.

FIG. 8 illustrates a right side view of an embodiment of the EV charger handle.

FIG. 9 illustrates a left side view of an embodiment of the EV charger handle.

FIG. 10 illustrates a front view of an embodiment of the EV charger handle.

FIG. 11 illustrates a back view of an embodiment of the EV charger handle.

FIG. 12 illustrates a bottom view of an embodiment of the EV charger handle.

FIG. 13 illustrates a top view of an embodiment of the EV charger handle.

FIG. 14 is an exploded view of another embodiment of the EV charger handle of the present disclosure illustrating the parts in the EV charger handle.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

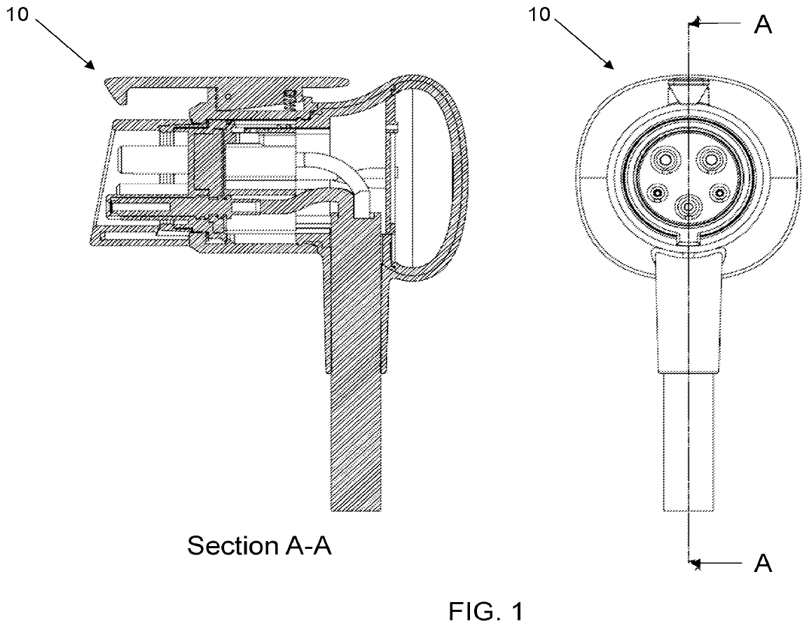

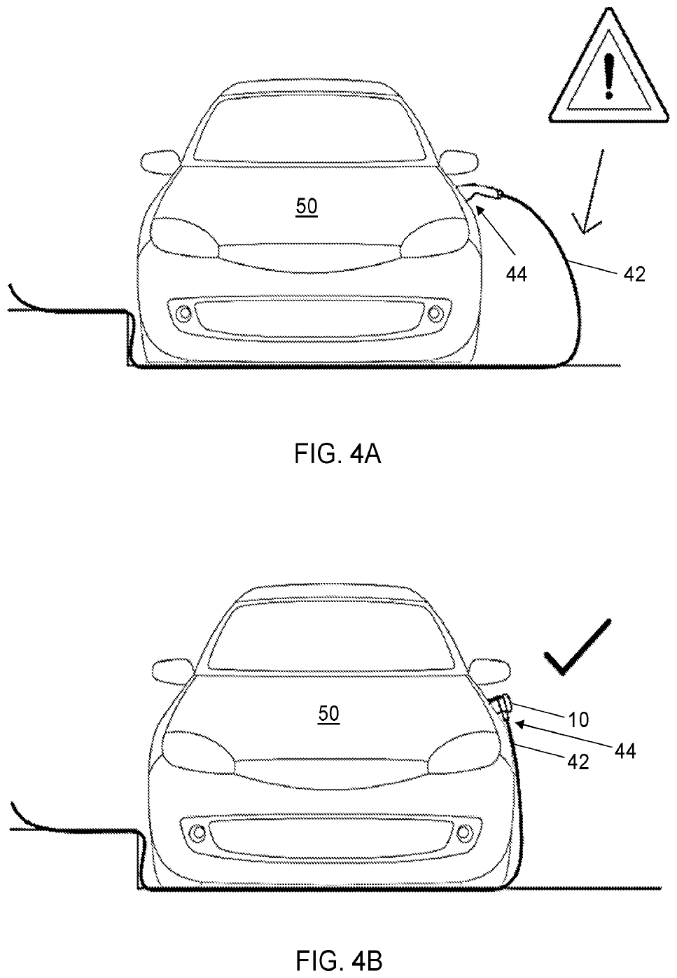

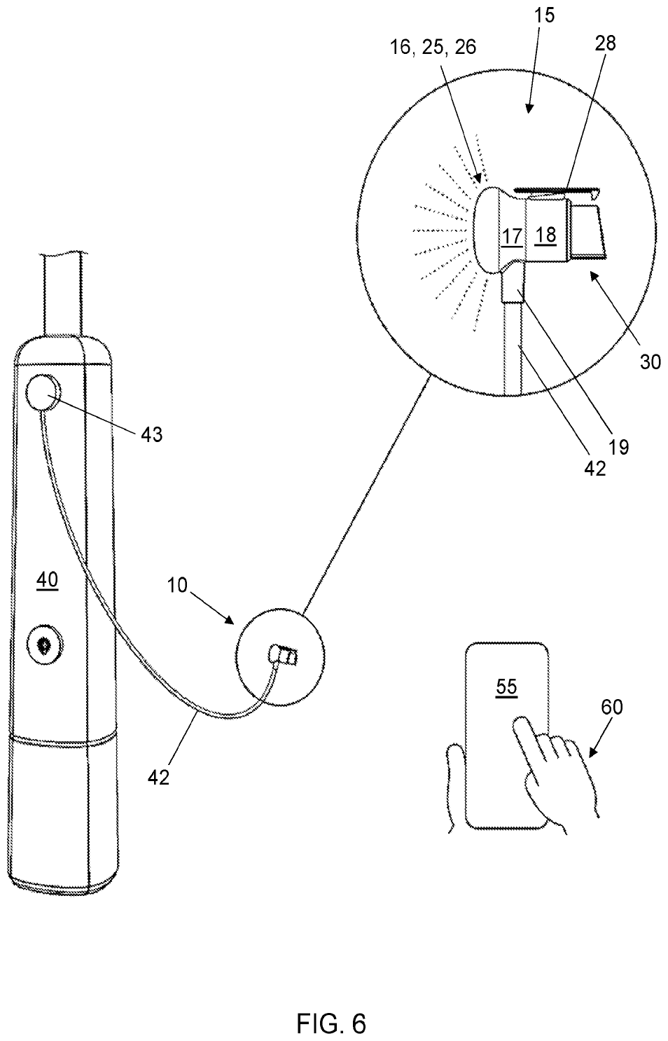

The present disclosure provides an electric vehicle (EV) charger 10, as shown in FIG. 1. The EV charger handle 10 includes a compact housing 15 configured to direct a charging cable 42 from an EV charging station 40 to an electrical receptacle 44 in an EV 50 at a 90 degree angle, as shown in FIGS. 4B and 6. In an embodiment, the charging cable 42 can be directed at a right angle to a direction of the connection axis. The internal components of the EV charger handle 10 are configured to provide a low profile or compact envelope.

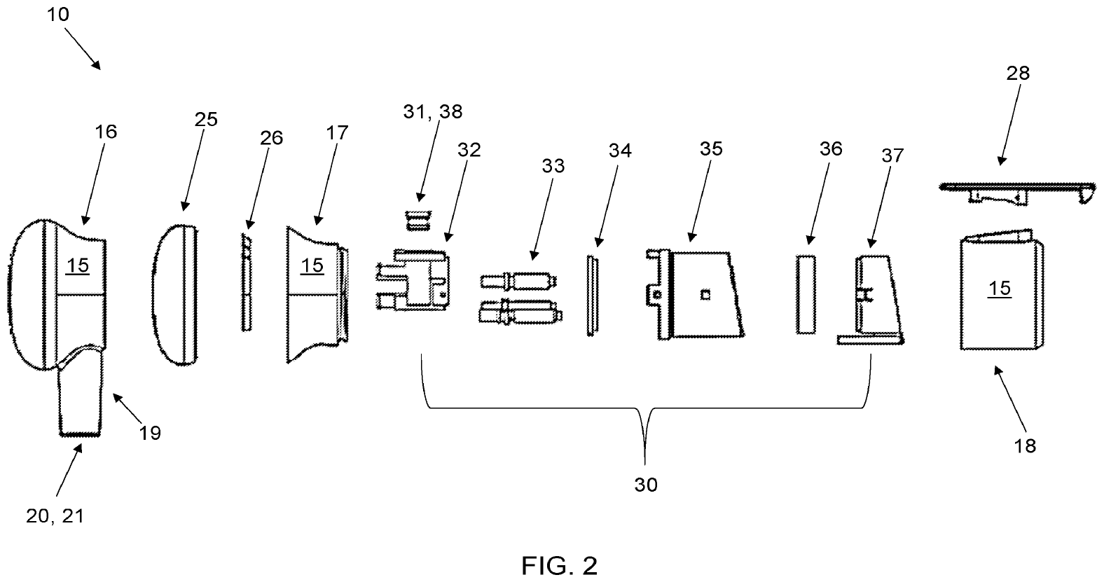

In an embodiment, the EV charger handle 10 includes a charging plug 30 to connect into the charging socket of the EV 50. The EV charger handle 10 may include any of a type 1, type 2, type 3 or a type 4 plug. Further, the charging cable 42 may be an insulated cable housing multiple individually insulated electric wires. These wires are connected to the contact pins 33 of the charging plug 30 inside of the housing 15, as shown in FIG. 2. The housing 15 of the EV charger handle 10 may be further configured to be waterproof to protect the connection site of the electrical wires from damage. The EV charger handle 10 may be further configured to be colored with bright colors and/or reflective paints to be easily identifiable in low visibility environments.

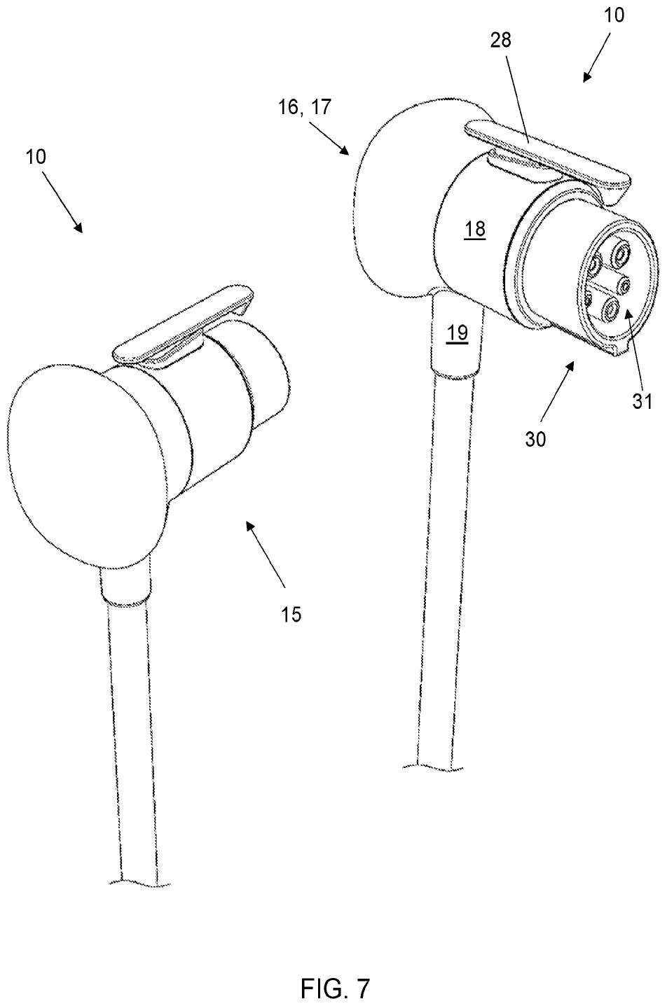

As shown in FIGS. 2 and 7, in an embodiment, the EV charger handle 10 includes a handle 19. The handle 19 may include two or more parts that allow the cable to be fed through the housing 15 and the cable strain relief 21, to then be crimped to the entrained contact pins 33. The components are then fastened (e.g., snapped) together to create an assemblage in which the cables and contact pins 33 could not be crimped otherwise while still imparting the necessary structural rigidity and sealing between the charging plug shell 35 and the interior structure to ensure safe operation of the charging plug 30. A secondary cylindrical structure can be assembled over the charging plug shell 35 and internal structure, sealing against the back housing and charging plug shell 35 to create a sealed volume around the interior structure. The secondary cylindrical structure can include the barrel 18, which can fasten against the thorax 17 to create a waterproof seal, such as by compression of an o-ring or overmolded gasket. This cylindrical structure can be assembled via a thread, adhesive, ultrasonic welding, or other techniques. In the case of a thread method, an o-ring, gasket, or seal can be included on the fore and aft of the cylinder. The fore edge, as described by the direction of assemblage, has a plain face which can carry an o-ring or seal, and the aft edge has either a captive o-ring or seal in the interior surface, or has a slight ridge or overhang which mates with a complementary ledge or overhang on the charging plug shell 35, which the fore edge can easily pass over without impingement.

As shown in FIGS. 2, 3, and 6, one or more powered light sources 26 can be included in the housing 15. The light sources 26 can at a minimum be turned on or off, or increased and decreased in intensity such that various patterns or flashing can be created. The light source 26 can be independently or separately powered from the electrical connection of the charging circuit. When the EV charger handle 10 is removed from its dock in the EV charging station 40, the light source 26 can be alternatively turned on and off at a frequency so as to create a pattern that draws attention to itself without being too high frequency as to be imperceptible to the human eye, or potentially cause visual distress to those sensitive to flashing lights. This may continue until the EV charger handle 10 is connected to an EV 50, which can provide the operator with a high visibility accessory and can ensure that passing drivers and vehicles can more easily perceive them. Once connected, the light can remain on, or only remain on when the ambient lighting conditions are such that the illumination of the handle creates an improvement in its visibility. This state can be maintained by the light source 26 until it is unplugged from the vehicle, at which point it can revert to its flashing operation until returned to its dock in the EV charging station 40. Other light sequences are possible.

The light sequences and/or color can change to indicate various states of charging or operability. For example, the intensity, brightness, and/or color can change. The light can remain on when the EV charger handle 10 is docked to indicate states such as a broken station that needs repair or a station that has a reservation.

FIG. 2 shows an exploded view of the various parts of the EV charger handle 10. The EV charger handle 10 includes a housing 15. The housing 15 is formed by an overmold 16, a thorax 17, and a barrel 18. The overmold 16 may be constructed with a thermoplastic elastomer (TPE) material to allow the user 60 to grip the EV charger handle 10. Other grip materials such as silicone and rubber may be used. The choice of material is not limited herein, and any material may be used.

The overmold 16 may include a light transmitting assembly 25 configured to receive and partially transmit light from a light source 26. The overmold 16 can include an aperture for the light transmitting assembly 25 or the overmold 16 itself can be at least partially translucent. The light transmitting assembly 25 may be constructed with any material exhibiting translucent or transparent properties. The light transmitting assembly 25 may further be constructed with a rigid or a semi-rigid material. Alternatively, the light transmitting assembly 25 may include two or more components that are jointly molded using a double shot injection mold. The light transmitting assembly 25 may also include light guiding features to control the locations on the light transmitting assembly 25 where visible light is emitted from the light transmitting assembly 25 and/or the overmold 16.

The light transmitting assembly 25 can have various shapes, such as a circle, square, cube, prism, or a dome.

While disclosed with the light transmitting assembly 25, the light feature can be implemented on another area of the EV charger handle 10.

The overmold 16 may further include or encompass a light source 26. In an embodiment, the light source 26 may be separate from the overmold 16. The light source 26 may be disposed inside the light transmitting assembly 25. The placement of the light source 26 inside the light transmitting assembly 25 is not limited in the embodiments disclosed herein. The light source 26 may be a light emitting diode (LED). Alternatively, the light source 26 may also be any one of incandescent lights, fluorescent lights, or gas discharge light types. The LED light source discussed herein may further include an LED array having a plurality of LEDs configured to emit multi-colored light. Specifically, the LED array may include any combination of red, green, blue, or white LEDs (e.g., RGB, RGB+W). The white LEDs (or other white light sources) can be used with a colored film to produce different colors. These LEDs may be driven by forward currents of varying intensities to produce any color in the visible spectrum as is readily understood by a person of ordinary skill level in the art. The LED forward currents may be supplied by a power source such as a lithium-ion battery through a control circuit or through the power supplied elsewhere to the EV charger handle 10. The power source and the control circuit may be mounted in a PCB board inside the light transmitting assembly.

The light source 26 discussed in embodiments disclosed herein may also include additional circuitry or a processor to allow remote control of lighting functions via a wireless device 55 to control LED array parameters such as color, intensity and frequency (FIG. 6). The wireless device 55 may be any electronic device providing a human computer interaction (HCl) and a wireless communication means such as, but not limited to, a mobile phone, a smart watch, personal digital assistants, laptops, tablets, EV tablets, etc. The wireless device 55 may include a non-transitory storage medium storing a software application program wherein the program instructs a processor included in the wireless device to provide a graphical user interface to the user to control the operations of the light source.

Embodiments of the system can include a processor, which is programmed in software and/or firmware to carry out the functions that are described herein, along with suitable digital and/or analog interfaces for connection to the other elements. Alternatively or additionally, the system can include hard-wired and/or programmable hardware logic circuits, which carry out at least some of the functions described herein. Program code or instructions for the processor to implement various methods and functions disclosed herein may be stored in readable storage media, such as a memory.

Referring back to FIG. 2, the housing 15 may further include a thorax 17. In an embodiment, the thorax 17 may be part of the overmold 16. In another embodiment, the thorax may be separate from the overmold 16. The thorax 17 may be configured to securely seal the light source 26 into the light transmitting assembly 25.

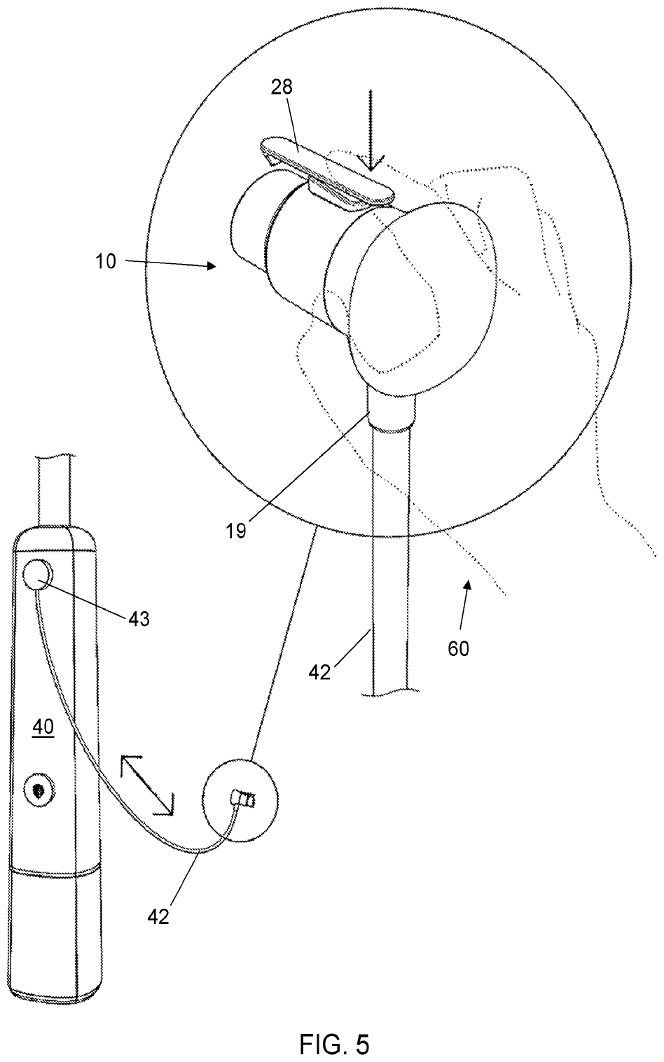

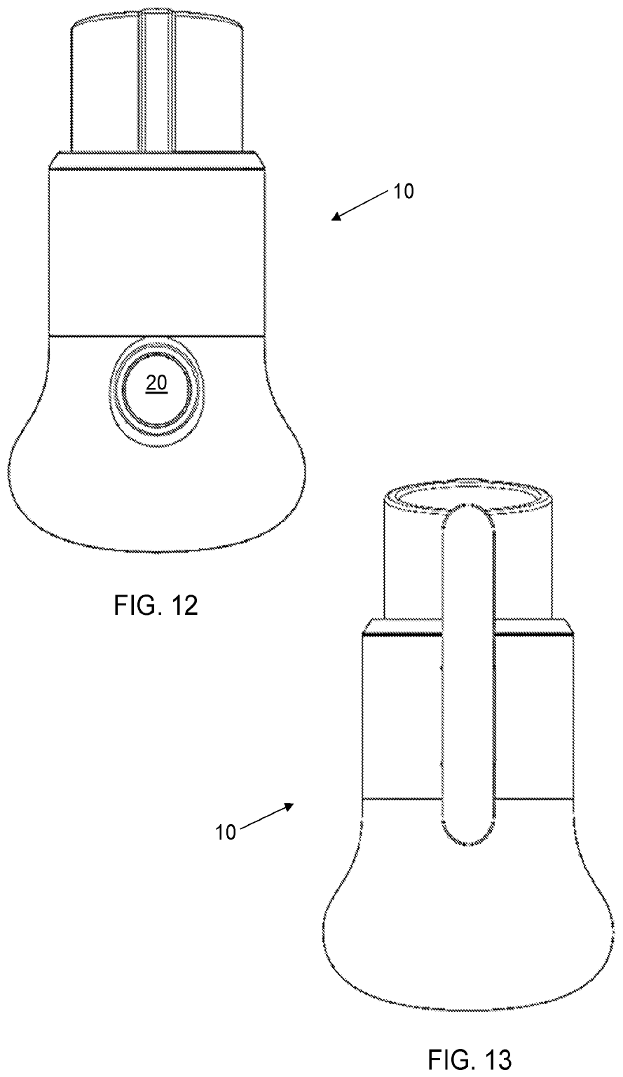

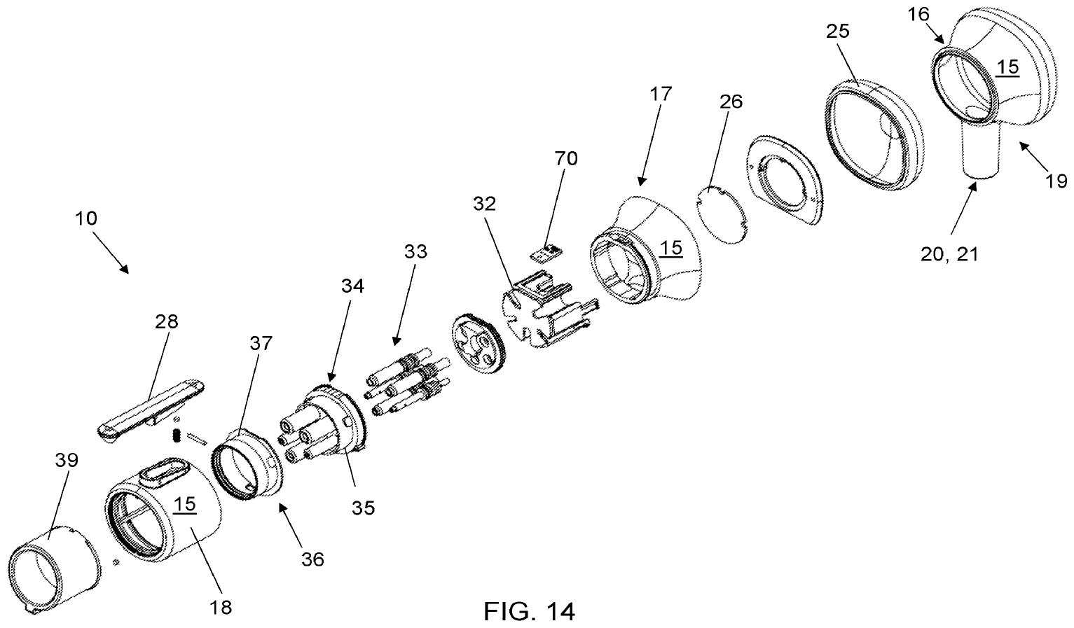

The housing 15 may further include a charging cable insert 20 that is perpendicular to the axis of the EV charger handle 10. In an embodiment, the charging cable insert 20 is configured to receive a charging cable 42 from an EV charging station 40, as shown in FIGS. 5 and 12. In an embodiment, the charging cable insert 20 may be part of the handle 19. In another embodiment, the charging cable insert 20 may be part of the thorax 17. In another embodiment, the charging cable insert 20 may be part of the overmold 16. The angle of insertion for the charging cable 42 provided by the housing 15 of the EV charger handle 10 is perpendicular to a connection axis of the connection between EV charger handle 10 and the electrical receptacle 44 in an EV 50. This facilitates compact connection of the EV charger handle 10 with the EV 50. FIG. 4A shows a previous EV charger handle which provides a hazard due to the tendency of the charging cable 42 to extend over at least one foot distance away from the car, and potentially into the path of oncoming traffic in most use-case scenarios. FIG. 4B shows the EV charger handle 10 of the embodiments disclosed herein where the right angle of insertion, provided by the charging cable insert 20 to the charging cable 42 facilitates a compact and snug connection of the EV charger handle 10 and the EV 50. As shown FIG. 4B, the EV charger handle 10 of the embodiments disclosed herein stays close to the body line of the EV 50.

An orientation where the EV charger handle 10 is perpendicular to a connection axis of the connection between EV charger handle 10 and the electrical receptacle 44 changes the assembly process of the EV charger handle 10. The cable is assembled into the housing 15, and the contact pins 33 are crimped after insertion into the thorax 17 and/or overmold 16. A series of structures are used to hold the contact pins 33 in position and guide the internal conductors into the correct position, which enables reliable and consistent assembly.

In an embodiment, the cable and conductors are bent and inserted into a charging plug mount 32 which maintains the correct position and bend radius of the conductors. The charging plug mount 32 also may include features which hold contact pins 33 in position, instead of the cable itself, which can ensure more secure engagement than is possible with the individual conductors. The charging plug mount 32 can be designed such that it has a series of radial features which facilitate the ease of assembly, while also maintaining the proper separation between any current carrying conductors, to ensure that the proper isolation can be achieved. The construction of the charging plug mount 32 and the thorax 17 are such that the cable and the contained conductors are maintained at the appropriate position during assembly to allow for the 90°angle rotation while still maintaining the necessary bend radiuses for the individual conductor diameters. This occurs by features in the thorax 17 which can entrain the cable, in conjunction with the cavities or protrusions in the charging plug mount 32 which hold the cable or contact pins 33, which are designed so as to allow elastic deformation on the insertion of either the structures of the charging plug mount 32 or the insulation jacket of the conductors.

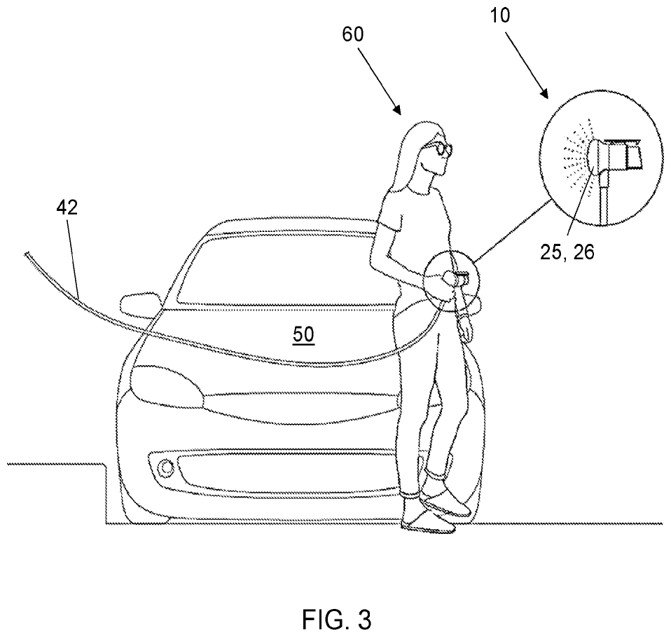

FIG. 3 illustrates an EV charger handle 10 of the present disclosure providing a visual indication to a user 60. The EV charger handle 10 can emit a steady or pulsing light to indicate that the EV 50 is charging, which can alert traffic and pedestrians in dim light.

The visual indication provided by the aforementioned light source not only provides visibility to passing vehicles and pedestrians, but it also provides illumination for the user during plugging and unplugging of the EV charger handle 10 to an EV 50 in all weather and lighting conditions. This reduces collision hazard for the user 60, the EV 50, the EV charger handle 10, the charging cable 42, and the EV charging station 40 from roadway traffic. For example, a steady or pulsing light can be emitted by the EV charger handle 10 after removal from the EV charging station 40 to indicate to traffic that a charge process is going to start. This can keep the user safe and visible to traffic when entering the street.

Turning back to FIG. 2, the charging cable insert 20 may further include a cable strain relief 21. This can be additional cable length of the charging cable 42 or another mechanism that reduces cable strain. The cable strain relief 21 can prevent over-bending at the point of exit from the rest of the handle where it is most prone to tight bends. The cable strain relief 21 can provide protection and relief from the stresses of wire and cable connections of the charging cable 42 and can prevent the connections or cables of the charging cable 42 from breaking.

Referring back to FIG. 2, the EV charger handle 10 further includes a charging plug 30 configured to be inserted into an electrical receptacle 44 in the EV 50. The charging plug 30 includes a switching grommet 31 and a charging plug mount 32. The switching grommet 31 includes a push button 38 embedded in the switching grommet 31, which can provide waterproof sealing. The charging plug mount 32 may facilitate securing the EV charger handle 10 into an EV 50. The charging plug 30 further includes a plurality of female contact pins 33. The plurality of female contact pins 33 may facilitate securing electric connection with male contact pins on an EV 50. The charging plug 30 further includes a pin restrainer 34. The pin restrainer 34 may facilitate securing the plurality of female contact pins 33 to the charging plug 30. The charging plug 30 may further include an inner charging plug shell 37. The inner charging plug shell 37 is configured to house the switching grommet 31, the charging plug mount 32, the plurality of female contact pins 33, and the pin restrainer 34. The charging plug 30 components may be fastened and snapped together to create an assemblage. The charging plug 30 further includes an outer charging plug shell 35 and a charging plug grommet 36. The outer charging plug shell 35 may be configured to be secured with the inner charging plug shell 37 by the charging plug grommet 36.

The housing 15 of the EV charger handle 10 further includes a barrel 18 that secures the overmold 16 to the charging plug 30. The outer charging plug shell 35 is assembled over the inner charging plug shell 37 and the barrel 18 providing a fastening against the overmold 16 and the barrel 18 to create a waterproof seal. The outer charging plug shell 35 can be assembled via a thread, adhesive, snap connection, or ultrasonic welding. The charging plug grommet 36 may be an o-ring, a gasket, or a seal, and may be fitted between the outer and inner charging plug shell to provide IP44 protection and a waterproof seal between the pin holder and the components of the barrel 18.

FIG. 14 is an exploded view of another embodiment of the EV charger handle 10. The EV charger handle 10 in FIG. 14 is similar to that in FIG. 2, but includes a Hall Effect sensor board 70 on the charging plug mount 32 instead of a push button 38 embedded in the switching grommet 31. The EV charger handle 10 further includes a pin nozzle shroud 39 connected to the barrel 18 and configured to engage with an EV 50 when the EV charger handle 10 is connected to the EV 50.

The EV charger handle 10 further includes a rotating latch 28 as shown in FIG. 5. The rotating latch 28 may be situated on the barrel 18, as shown in FIG. 6. The rotating latch 28 may be configured to latch the EV charger handle 10 to the EV charging station 40 when the EV charger handle 10 is not in use and can be, for example, SAE J1772 Level 2 compatible. The rotating latch 28 may additionally be configured to retract and dispense the charging cable 42 from the cable mechanism 43 of the EV charging station 40. The rotating latch 28 can connect (e.g., snap) into a detent in the socket of the EV charging station 40 that receives the EV charger handle 10. This can lock the EV charger handle 10 in the socket of the EV charging station 40. The dimensions can be defined by the SAE J1772 standard for sockets. FIG. 5 shows the rotating latch 28 of the EV charger handle 10.

The rotating latch 28 may be spring-loaded such that it rotates about an attachment pin. The rotating latch 28 also may have an embedded magnet instead of a switch or push button 38. The magnet is sensed via a magnetic Hall Effect sensor board 70 (shown in FIG. 14) which senses if the rotating latch 28 is depressed and how far it is pressed. The use of a magnet and a magnetic Hall Effect sensor can enable for the user to depress the latch at varying amounts in order to activate the dispensing or retraction of the cable at varying speeds. For example, pressing down further on the rotating latch 28 can make the mechanism increase in speed.

Further, in an embodiment, there may be a cavity within the rotating latch 28 configured to interface with the switching grommet 31 of the charging plug 30. Pushing down on the rotating latch 28 can depress the latch and actuate (e.g., depress) the switching grommet 31.

In an embodiment, the push button 38 in the switching grommet 31 may be configured to provide a waterproof seal to the EV charger handle 10, in response to being engaged by the rotating latch 28. FIG. 5 illustrates the controlling of the retraction and dispensing of the charging cable 42 using the rotating latch 28 in the EV charger handle 10 of the present disclosure. As shown by the arrow, a user 60 may push down on the rotating latch 28 to engage the push button 38.

FIG. 6 illustrates an embodiment of operation. The EV charger handle 10 can emit steady or pulsing light to communicate interaction states of the system. For example, light emission can occur when plugged into the EV charging station 40, when unplugged from the EV charging station 40, or when plugged into an electrical receptacle 44 of an EV 50. The light emission can also be paired with the interaction with the EV charging station 40 and/or a mobile app on a user's 60 wireless device 55.

This light source 26 can also be such that it can change color and intensity to create more easily visible and less jarring lighting patterns than that described elsewhere herein. By having multiple colors, and adjustable intensities, it becomes possible to provide additional information to either the users, traffic, or public officials at large. It is possible to indicate when a charge has been completed, if an EV 50 that is charging has overstayed its reservation or if an EV 50 is in violation of specific local parking regulations at that time. A processor can be used to change the color and intensity based on various inputs.

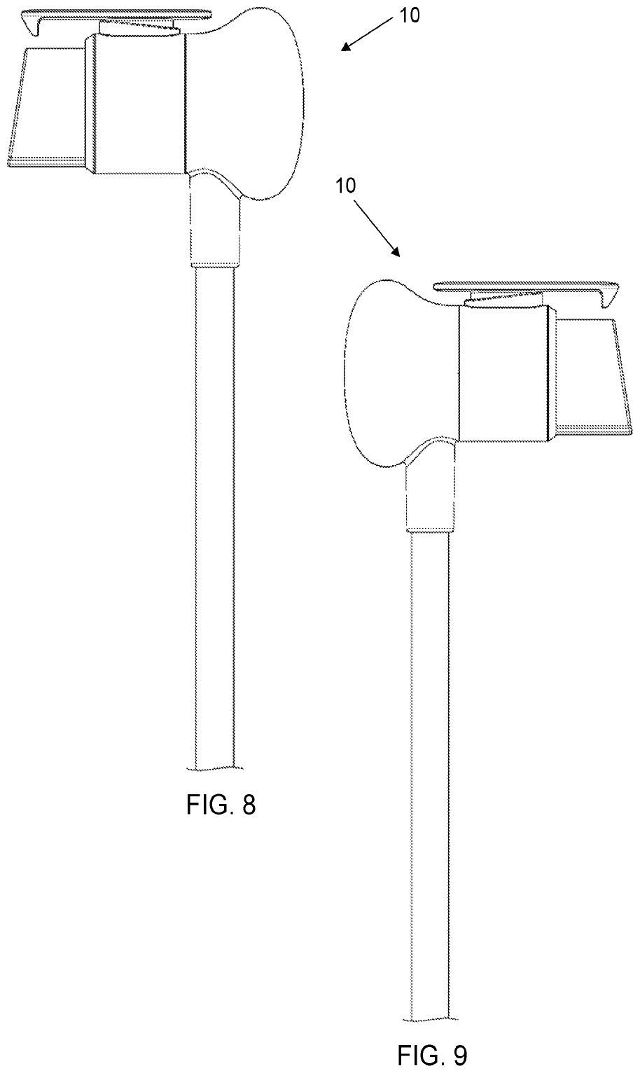

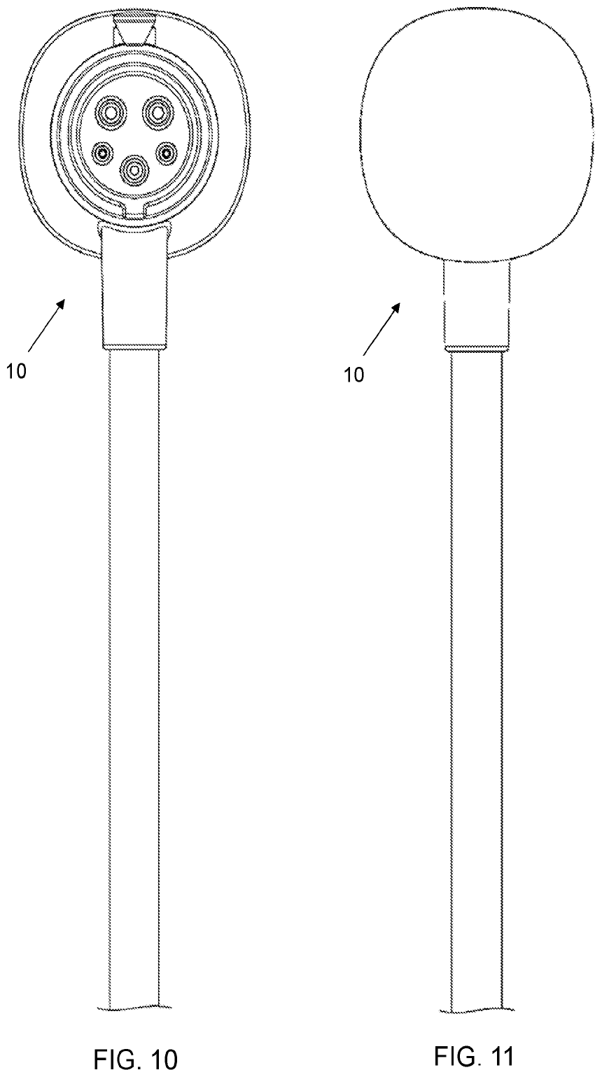

FIGS. 7-12 display various views of embodiments of the EV charger handle 10.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. An electric vehicle (EV) charger handle comprising:
a housing;
a charging cable insert perpendicular to the axis of the EV charger handle, wherein the charging cable insert is configured to receive a charging cable from an EV charging station; and
a charging plug configured to be inserted into an electrical receptacle in an EV, wherein the charging plug includes:
a switching grommet;
a charging plug mount configured to secure the EV charger handle into the EV;
a plurality of female contact pins configured to secure an electric connection with male contact pins in the electrical receptacle in the EV;
a pin restrainer configured to secure the plurality of female contact pins to the EV charger handle;
an inner charging plug shell configured to house the switching grommet, the charging plug mount, the plurality of female contact pins and the pin restrainer; and
an outer charging plug shell wherein the outer charging plug shell is secured to the inner charging plug shell by a charging plug grommet.

2. The EV charger handle of claim 1, wherein the EV charger handle is configured to direct the charging cable from the EV charging station to the electrical receptacle in the EV at a 90 degree angle.

3. The EV charger handle of claim 1, wherein the housing comprises an overmold, a thorax, and a barrel, wherein the barrel is disposed on the overmold to the EV charger handle.

4. The EV charger handle of claim 3, wherein the EV charger handle further comprises a rotating latch positioned on the housing.

5. The EV charger handle of claim 4, wherein the rotating latch is positioned on the thorax.

6. The EV charger handle of claim 4, wherein the rotating latch facilitates the control of dispense and retraction of the charging cable from the EV charging station.

7. The EV charger handle of claim 4, wherein a push button in the switching grommet is configured to provide a waterproof seal to the EV charger handle, in response to being engaged by the rotating latch.

8. The EV charger handle of claim 3, wherein the overmold comprises a light transmitting assembly configured to receive and transmit light from a light source.

9. The EV charger handle of claim 8, wherein the light source is disposed inside the light transmitting assembly.

10. The EV charger handle of claim 8, further comprising a processor in electronic communication with the light source.

11. The EV charger handle of claim 10, wherein the light source is configured to be controlled by a wireless device.

12. The EV charger handle of claim 8, wherein the light source is an LED.

13. The EV charger handle of claim 12, wherein the light source further comprises a programmable RGB LED light source.

14. The EV charger handle of claim 1, further comprising a light transmitting assembly configured to receive and transmit light from a light source.

15. The EV charger handle of claim 1, wherein the pin restrainer is annular shaped.

16. The EV charger handle of claim 1, wherein the charging cable insert comprises a cable strain relief configured to provide protection to the charging cable.

17. The EV charger handle of claim 1, further comprising a Hall Effect sensor board disposed on the charging plug mount.
